(19) United States
(12) Patent Application Publication
(10) Pub. No.: US 2025/0158403 A1
(43) Pub. Date: May 15, 2025

(54) PREDICTIVE POWER DISTRIBUTION UNIT OUTPUT LOAD SWITCHING FOR INPUT PHASE BALANCING

(71) Applicant: International Business Machines Corporation, Armonk, NY (US)

(72) Inventors: John S. WERNER, Fishkill, NY (US); Luke L. JENKINS, Poughkeepsie, NY (US); Arkadiy O. TSFASMAN, Wappingers Falls, NY (US); John TOROK, Poughkeepsie, NY (US)

(21) Appl. No.: 18/508,644

(22) Filed: Nov. 14, 2023

(51) Int. Cl. H02J 3/14; G05B 15/02; H02J 13/00

(52) U.S. Cl. CPC H02J 3/14; G05B 15/02; H02J 13/00002

(57) ABSTRACT

Disclosed embodiments provide methods, systems, and computer program products for implementing predictive three-phase power distribution unit (PDU) output load switching for input phase balancing. Disclosed embodiments measure PDU output port power values for powering a plurality of loads over time, perform pattern recognition on the PDU output port power values over time to produce recognized power patterns; and create switching rules based on the recognized power patterns to provide input phase load balancing, wherein the switching rules include at least one of (i) predicted output port power values for a periodic time interval, or (ii) predicted output port power values based on the measured PDU output port power values associated with the loads. Disclosed embodiments switch input phase connection to one or more PDU outputs based on the switching rules.

### BACKGROUND

The present invention relates to power distribution units, and more specifically, to providing predictive three-phase power distribution unit (PDU) output load switching for input phase balancing.

Power Distribution Units (PDUs) are used to distribute power to attached electrical equipment. Typically, multiple PDUs are used in a datacenter, which may have three-phase power inputs and may provide single phase power at output ports connected to respective loads, such as computers, peripherals, and computer cooling equipment. Unbalanced input phases can result where output ports that connect to one input phase draw more power than other output ports that connect to other input phases (e.g., with unbalanced power of the output loads). Unbalanced PDU input phases can waste power (e.g., due to power (IR) distribution effects) and limit utilization of three-phase power sources, which can lead to exceeding line cord ratings on individual phases, excessive heating in cables, connectors, relays, and/or circuit breakers, and tripping upstream circuit breakers, which in turn can lead to tripping upstream circuit breakers and even cause failures to product safety standards.

### SUMMARY

Embodiments of the present disclosure are directed to methods, systems, and computer program products for implementing predictive three-phase power distribution unit (PDU) output load switching for input phase balancing.

According to one embodiment of the present disclosure, a non-limiting computer implemented method is provided. The method comprises measuring Power Distribution Unit (PDU) output port power values of respective associated loads over time; performing pattern recognition on the output port power values to produce recognized power patterns; and creating switching rules based on the recognized power patterns to provide input phase load balancing, where the switching rules include at least one of (i) predicted output port power values for a periodic time interval, or (ii) predicted output port power values based on the measured PDU output port power values associated with the loads. The method also includes switching input phases that connect to one or more PDU output ports based on the switching rules.

According to one embodiment of the present disclosure, a system is provided. The system includes one or more computer processors, and a memory containing a program which when executed by the one or more computer processors performs an operation. The operation comprises measuring Power Distribution Unit (PDU) output port power values of respective associated loads over time; performing pattern recognition on the output port power values to produce recognized power patterns; and creating switching rules based on the recognized power patterns to provide input phase load balancing, where the switching rules include at least one of (i) predicted output port power values for a periodic time interval, or (ii) predicted output port power values based on the measured PDU output port power values associated with the loads. The operation also includes switching input phases that connect to one or more PDU output ports based on the switching rules.

According to one embodiment of the present disclosure, a computer program product is provided. The computer program product includes a computer-readable storage medium having computer-readable program code embodied therewith, the computer-readable program code executable by one or more computer processors to perform an operation. The operation comprises measuring Power Distribution Unit (PDU) output port power values of respective associated loads over time; performing pattern recognition on the output port power values to produce recognized power patterns; and creating switching rules based on the recognized power patterns to provide input phase load balancing, where the switching rules include at least one of (i) predicted output port power values for a periodic time interval, or (ii) predicted output port power values based on the measured PDU output port power values associated with the loads. The operation also includes switching input phases that connect to one or more PDU output ports based on the switching rules.

### BRIEF DESCRIPTION OF THE DRAWINGS

FIG. 1 is a block diagram of an example computer environment for use in conjunction with one or more disclosed embodiments for implementing predictive three-phase power distribution unit (PDU) output load switching for input phase balancing;

FIG. 2 is a schematic and block diagram of an example system for implementing predictive three-phase PDU output load switching for input phase balancing of one or more disclosed embodiments;

FIGS. 3A and 3B together provide a flow chart illustrating example operations of a method for implementing predictive three-phase PDU output load switching for input phase balancing of one or more disclosed embodiments;

FIG. 4A is a schematic and block diagram of an example PDU including a switch bank of output load switches for an input power Wye-configuration of one or more disclosed embodiments;

FIG. 4B is a schematic and block diagram of an example Wye-configured PDU with switches that can connect output receptacles to more than one input line of one or more disclosed embodiments;

FIG. 5A is a schematic and block diagram of an example PDU including a switch bank of output load switches for an input power Delta-configuration of one or more disclosed embodiments;

FIG. 5B is a schematic and block diagram of an example Delta-configured PDU with switches that can connect output receptacles to more than one input line of one or more disclosed embodiments; and

FIG. 6 is a flow chart of example operations of a method for implementing three-phase power distribution unit (PDU) output load switching for input phase balancing of a disclosed embodiment.

### DETAILED DESCRIPTION

Disclosed embodiments enable enhanced PDU output load switching to balance input phases. Disclosed embodiments monitor output port power utilization and learn output port power utilization patterns over time, and use the learning to determine when to perform PDU output port switching to balance input phases.

According to an aspect of disclosed embodiments, a non-limiting computer implemented method is provided. The method comprises measuring Power Distribution Unit (PDU) output port power values of respective associated loads over time; performing pattern recognition on output port power values in the load power log to produce recognized power patterns; and creating switching rules based on the recognized power patterns to provide input phase balancing, where the switching rules include at least one of (i) predicted output port power values for a periodic time interval, or (ii) predicted output port power values based on the measured PDU output port power values associated with the loads. The method also includes switching input phases of one or more PDU output ports based on the switching rules. The method enables effective and efficient input phase load balancing with switching input phases of one or more PDU output ports based on recognized power patterns and predicted output port power values, which can prevent exceeding a line cord rating on individual phases thus prevent failing product safety standards, excessive heating in cables, connectors, relays, circuit breakers, and tripping upstream circuit breakers.

According to an aspect of disclosed embodiments, a system is provided. The system includes one or more computer processors, and a memory containing a program which when executed by the one or more computer processors performs an operation. The operation comprises measuring Power Distribution Unit (PDU) output port power values of respective associated loads over time; performing pattern recognition on the output port power values to produce recognized power patterns; and creating switching rules based on the recognized power patterns to provide input phase load balancing, where the switching rules include at least one of (i) predicted output port power values for a periodic time interval, or (ii) predicted output port power values based on the measured PDU output port power values associated with the loads. The operation also includes switching input phases that connect to one or more PDU output ports based on the switching rules. The system enables effective and efficient input phase load balancing with switching input phases of one or more PDU output ports based on recognized power patterns and predicted output port power values, which can prevent exceeding a line cord rating on individual phases thus prevent failing product safety standards, excessive heating in cables, connectors, relays, circuit breakers, and tripping upstream circuit breakers.

According an aspect of disclosed embodiments, a computer program product is provided. The computer program product includes a computer-readable storage medium having computer-readable program code embodied therewith, the computer-readable program code executable by one or more computer processors to perform an operation. The operation comprises measuring Power Distribution Unit (PDU) output port power values of respective associated loads over time; performing pattern recognition on the output port power values to produce recognized power patterns; and creating switching rules based on the recognized power patterns to provide input phase load balancing, where the switching rules include at least one of (i) predicted output port power values for a periodic time interval, or (ii) predicted output port power values based on the measured PDU output port power values associated with the loads. The operation also includes switching input phases that connect to one or more PDU output ports based on the switching rules. The computer program product enables effective and efficient input phase load balancing with switching input phases of one or more PDU output ports based on recognized power patterns and predicted output port power values, which can prevent exceeding a line cord rating on individual phases thus prevent failing product safety standards, excessive heating in cables, connectors, relays, circuit breakers, and tripping upstream circuit breakers.

An embodiment of the present disclosure further includes identifying a three phase input power configuration of a Delta-configuration input, or a Wye-configuration input. The embodiment enables efficiently configuring the PDU to implement predictive PDU output load switching for input phase balancing.

An embodiment of the present disclosure further includes configuring PDU output load switches, based on the Delta-configuration input, or the Wye-configuration input, wherein the PDU output load switches are used for the switching the input phases that connect to one or more PDU output ports. The embodiment enables efficiently configuring the PDU to implement predictive PDU output load switching for input phase load balancing.

Additionally, an embodiment of the present disclosure where the measuring the PDU output port power values of the PDU output ports that distribute power to the plurality of loads over time further comprises measuring current using respective current sensors coupled to each of the PDU output ports for providing a measured current signal for each of the respective loads. The embodiment enables efficiently obtaining the measured PDU output port power values of the plurality of loads over time to implement predictive PDU output load switching for input phase load balancing.

Additionally, an embodiment of the present disclosure where the performing pattern recognition on the PDU output port power values to produce recognized power patterns further comprises: performing pattern recognition on the PDU output port power values to recognize differing power utilization of one or more PDU output ports that lasts for at least a threshold period of time that change three-phase input load balancing. The embodiment enables efficiently producing recognized power patterns to effectively implement predictive three-phase PDU output load switching for input phase balancing.

Additionally, an embodiment of the present disclosure where the performing pattern recognition on the PDU output port power values to produce recognized power patterns further comprises: performing pattern recognition on the PDU output port power values to identify periodic times of differing power utilization of one or more loads of at least a threshold period of time that change three-phase input load balancing. The embodiment enables efficiently producing recognized power patterns to effectively implement predictive three-phase PDU output load switching for input phase load balancing.

Additionally, an embodiment of the present disclosure where the creating switching rules based on the recognized power patterns to provide input phase load balancing further comprises: further comprises: identifying predicted differing power utilization of one or more PDU output ports at predicted periodic times that change three-phase input load balancing. The embodiment enables efficiently and effectively implementing predictive PDU output load switching for input phase balancing using predicted periodic times of regular differing power utilization.

Additionally, an embodiment of the present disclosure where the creating switching rules based on the recognized power patterns to provide input phase load balancing further comprises: identifying predicted output port power values, of one or more PDU output ports, that change three-phase input load balancing. The embodiment enables efficiently and effectively implementing predictive PDU output load switching for input phase load balancing using predicted output port power values of one or more PDU output ports that change three-phase input load balancing.

Additionally, an embodiment of the present disclosure where the switching input phases that connect to one or more PDU output ports based on the switching rules further comprises: switching the input phases that connect to one or more PDU output ports a set time before the predicted periodic time interval of the differing output port power values of a differing power utilization. The embodiment enables enhanced overall PDU switching control using the predicted periodic time of the output port power values of differing power utilization.

Additionally, an embodiment of the present disclosure where the switching input phases that connect to one or more PDU output ports based on the switching rules further comprises: switching the input phases that connect to one or more PDU output ports for input phase load balancing based on predicted output port power values of differing power utilization predicted to last at least a threshold time interval. The embodiment enables enhanced overall PDU switching control using the predicted output port power values of differing power utilization predicted to last at least a threshold time interval, and avoids switching one or more PDU output ports to different input phases for brief increased power utilization predicted to last less than the threshold time interval.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

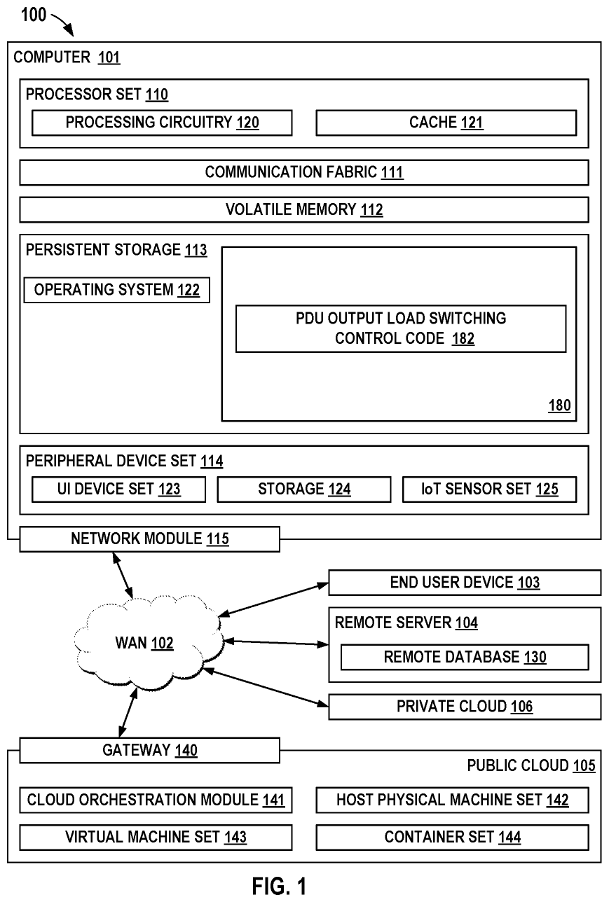

Referring to FIG. 1, a computing environment 100 contains an example of an environment for the execution of at least some of the computer code involved in performing the inventive methods, such as PDU Output Load Switching Control Code 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Disclosed embodiments provide predictive three-phase power distribution unit (PDU) output load switching for input phase balancing. The PDU includes a switch bank having respective switches connected to an associated respective PDU output port and connected load to enable the PDU output ports and loads to connect to different power input phases Phase A, Phase B, Phase C. The PDU includes a machine learning (ML) switch control module enabling predictive output load switching based on respective PDU output port power values for input phase balancing. The ML switch control module provides switch control signals to a switch bank to enable switching PDU output ports to connect to different power input phases Phase A, Phase B, Phase C for input phase load balancing of disclosed embodiments. The switching control measures PDU output port power values associated with the PDU output ports over time. In a disclosed embodiment, the switching rules are based on recognized power patterns, and include at least one of (i) predicted output port power values for a periodic time interval (e.g., at higher power utilization), or (ii) predicted output port power values based on the measured PDU output port power values associated with the loads.

In a disclosed non-limiting method, the ML switching control monitors PDU output port power over time, for example, the PDU output port power values change based on system utilization (e.g., higher power values may be seen during regular times of high system utilization), and stores a load power log. The ML switching control performs pattern recognition on the PDU output port power values over time to control switching PDU output ports. such that they connect to different input phases. In a disclosed embodiment, the ML switching control creates rules to assign PDU output ports to certain input phases for optimal power balancing based on typical load power patterns that last for at least a threshold period of time (e.g., at least 5 minutes, at least 30 minutes, and the like). The switching control performs predictive analysis that can also detect routine periodic time intervals of differing workload (e.g., higher workload at stock market open or beginning of bank hours) to pre-emptively re-assign PDU output ports to different input phases in anticipation of changes in workload.

In a disclosed embodiment, the ML switching control module, based on brief power utilization changes (e.g., predicted for less than 30 seconds), holds the PDU output ports with the current switch configuration (e.g., to provide enhanced switching and increase life of the load switches). Disclosed embodiments prevent the PDU from switching back and forth for power utilization changes that are borderline or short bursts of differing utilization. The ML switching control module, based on the switching rules, operatively controls the load switches to balance the inputs phases. In a disclosed embodiment, the ML switching control module operatively controls switching of the load switches to balance the inputs phases, for example, predicted power utilization predicted to last for at least a threshold time duration (e.g., predicted for 10 minutes), for switching the connection between PDU output ports and input phases (e.g., one or multiple output ports are switched). In a disclosed embodiment, the ML switching control module 208, based on the workload (e.g., higher power utilization to last at least a threshold time duration) predicted to change at a regular, periodic time interval (9:30 am EST), switches output ports to different input phases 30 seconds prior to the predicted time.

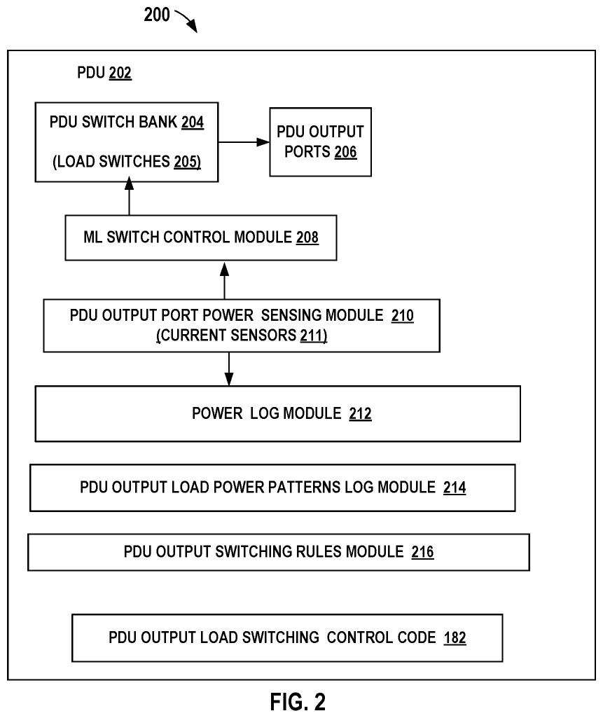

FIG. 2 illustrates an example system 200 of disclosed embodiments. System 200 can be used in conjunction with the computer 101 and the computing environment 100 of FIG. 1 and the PDU Output Load Switching Control Code 182 for implementing inventive methods of disclosed embodiments.

System 200 includes a power distribution unit (PDU) 200, which supports Delta and Wye input power configurations in accordance with a disclosed embodiment. System 200 includes a PDU switch bank 204 including an array of output load switches 205 selectively controlled for connecting one or more power input lines or phases Phase A, Phase B, and Phase C to PDU output power ports 206 of disclosed embodiments. System 200 includes a machine learning (ML) switch control module 208 in accordance with a disclosed embodiment operatively controlling the plurality of output load switches 205 of the PDU switch bank 204 in accordance with disclosed embodiments. System 200 includes a PDU output port power sensing module 210 for providing sensed power data to the ML switch control module 208, and optionally telemetry data to the computing environment 100 for measuring PDU output port power values over time of respective PDU output ports 206, that distribute power to a plurality of loads. In a disclosed embodiment, a respective current sensor 211, is coupled to each of the PDU output ports 206 that are connected to the plurality of load switches 205 of switch bank 204, providing a measured current signal for each of the respective PDU output ports 206. System 200 includes a power log module 212 for storing the measured PDU output port power values of the PDU output ports 206 over time. System 200 includes a PDU output load patterns log module 214 that stores recognized power patterns produced by performing pattern recognition on the PDU output port power values over time. System 200 (e.g., using the ML switch control module 208 and PDU Output Load Switching Control Code 182 of disclosed embodiments) creates switching rules based on the recognized power patterns for input phase load balancing. In a disclosed embodiment, the switching rules include at least one of (i) predicted output port power values for a periodic time interval, or (ii) predicted output port power values based on the measured PDU output port power values associated with the loads. System 200 includes a PDU output switching rules module 216 that stores the created switching rules based on the recognized power patterns for input phase balancing, and stores updated switching rules that can be periodically changed.

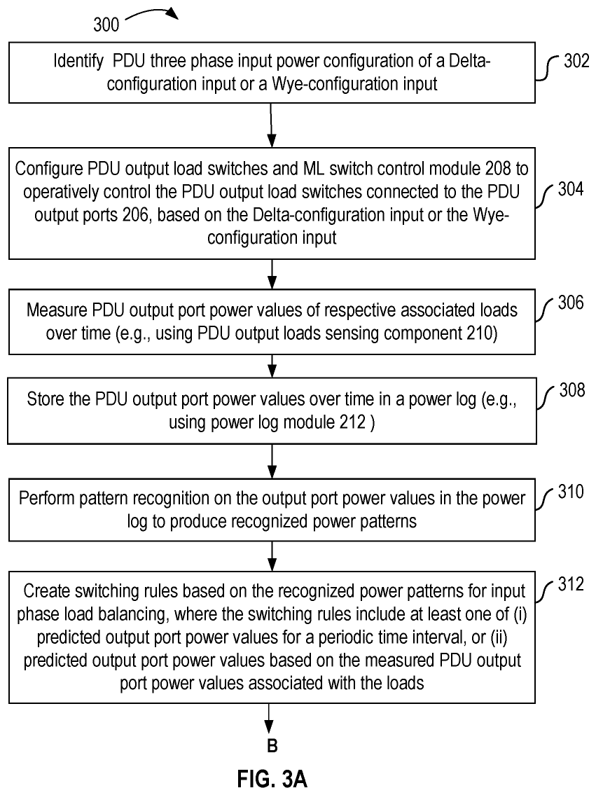

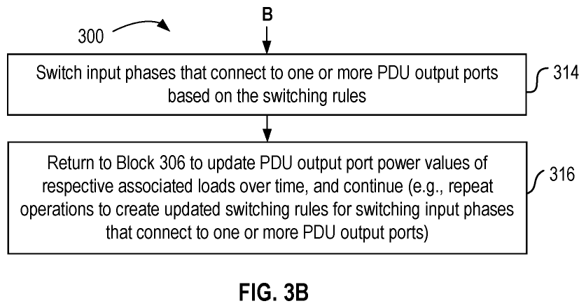

FIGS. 3A and 3B together illustrate example operations of a method 300 for implementing predictive PDU output load switching for input phase load balancing of a disclosed embodiment. The method 300 can be implemented by the system 200 in conjunction with the computer 101 of the computing environment 100 of FIG. 1 with the PDU Output Load Switching Control Code 182.

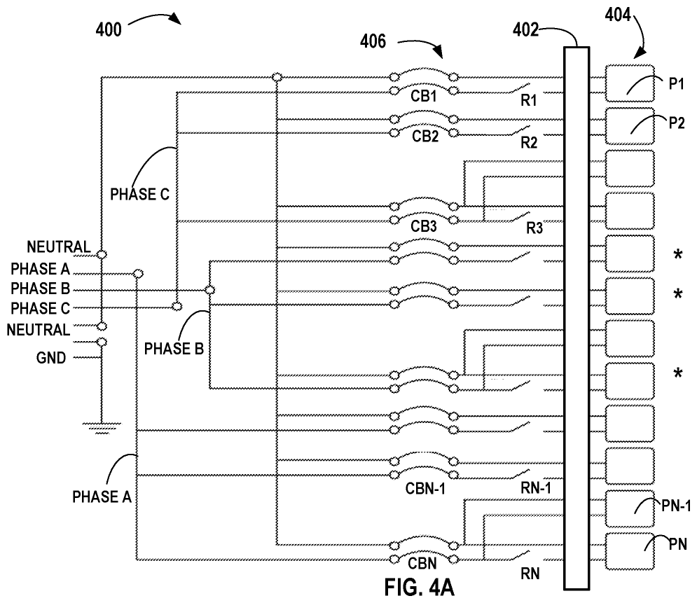

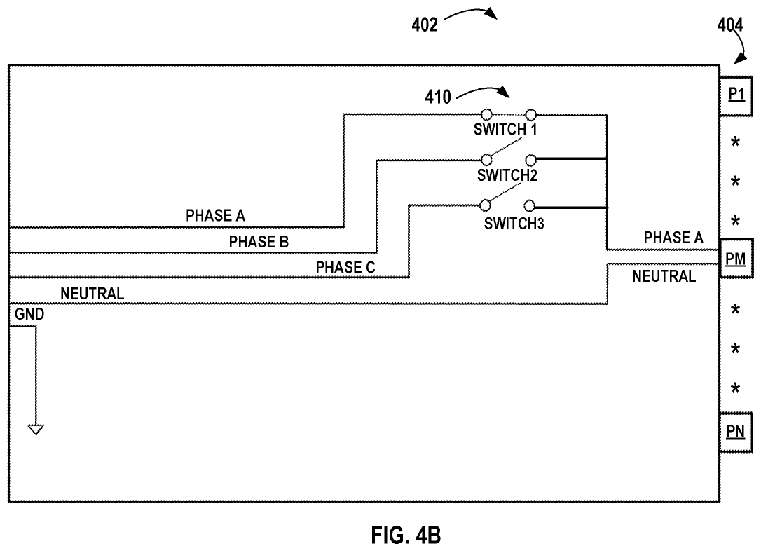

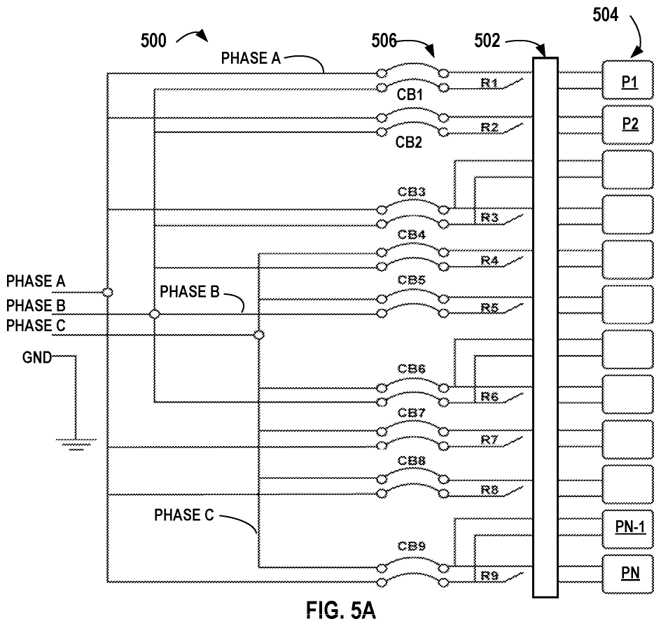

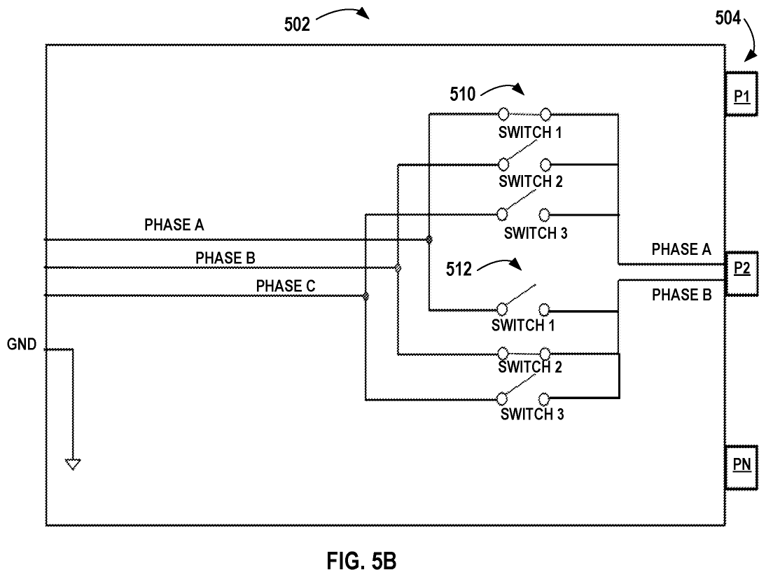

At block 302, system 200 identifies a PDU three phase input power configuration of a Delta-configuration input, or Wye-configuration input. FIG. 4A illustrates an example PDU 400 including a switch bank 402 for a Wye-configuration input (e.g., corresponding to PDU 202 and switch bank 204 of output load switches 205 of FIG. 2). FIG. 5A similarly illustrates an example PDU 500 including a switch bank 502 of output load switches for a Delta-configuration input. At block 304, system 200 configures the PDU output load switches 205 and the ML switch control module 208 to operatively control the PDU output load switches 205 connected to the PDU output ports 206, based on the identified one of the Delta-configuration input, or the Wye-configuration input. In a disclosed embodiment, the switch bank 204 of the Wye-configuration PDU includes power inputs Phase A, Phase B, Phase C, Neutral, and Ground, and provides respective single phase power output ports 206 to distribute power to the respective connected loads. FIG. 4B illustrates example PDU output load switches 410, SWITCH1, SWITCH2, and SWITCH3 of the Wye-configuration PDU. FIG. 5B illustrates example PDU output load switches 510, SWITCH1, SWITCH2, and SWITCH3 and 512, SWITCH1, SWITCH2, and SWITCH3 of the Delta-configuration PDU. For example, the switch bank 402 of the Wye-configuration PDU connects different output ports 404 to different input phases (e.g., output ports 1-3 are connected to Phase A, Neutral, and Ground, output ports 4-6 are connected to Phase B, Neutral, and Ground, and output ports 7-9 are connected to Phase C, Neutral, and Ground). In a disclosed embodiment, the switch bank 410 of the Wye-configuration PDU (e.g., as illustrated in the example PDU output load switches 410, SWITCH1, SWITCH2, and SWITCH3 in FIG. 4B) includes three switches connected to each PDU power output port 404 for respectively switching in one of Phase A, Phase B, or Phase C to the respective PDU output ports 404 that distribute power to associated one or more loads, and the Neutral input is connected to each power output port 404 connected to the output loads. In a disclosed embodiment, the switch bank 502 of the Delta-configuration PDU includes power inputs Phase A, Phase B, and Phase C, and Ground (in the Delta-configuration, the Neutral input is not used), and connects respective different output ports 504 that distribute power to associated one or more loads to different input phases (e.g., output ports 1-3 are connected to Phase A, Phase B, and Ground, output ports 4-6 are connected to Phase B, Phase C, and Ground, and output ports 7-9 are connected to Phase C, Phase A, and Ground). In a disclosed embodiment, for example, the switch bank 510 of the Delta configuration PDU includes six switches for each PDU output port 504 for respectively switching in one of Phase lines A, B, Phase lines B, C, or Phase lines C, A to PDU output ports that distribute power to associated respective loads.

At block 306, system 200 measures PDU output port power values over time, for example, using current sensors 211 of the PDU output power load sensing component 210 of FIG. 2. At block 308, system 200 stores the PDU output port power values in a power log, for example, storing PDU output port power values for each output port 206 in the power log module 212. At block 310, system 200 performs pattern recognition on output port power values in the power log to produce recognized power patterns. At block 312, system 200 creates switching rules based on the recognized power patterns to provide input phase load balancing, where the switching rules include at least one of (i) predicted output port power values for a periodic time interval, or (ii) predicted output port power values based on the measured PDU output port power values associated with the loads. In a disclosed embodiment, the switching rules are created in accordance with the recognized power patterns, and for example, are stored in the PDU output switching rules module 216 in FIG. 2.

For example at block 312 in a disclosed embodiment, system 200 creates the switching rules based on the recognized power patterns, where the switching rules include predicted output port power values for a periodic time interval. For example, the switching rule is used for switching input phases that connect to one or more PDU output ports 206 in response to periodic time intervals of predicted differing PDU output port power values due to changes in power utilization of one or more loads that impact PDU input phase load balancing. For example, the switching rule can provide switching input phases for better input phase load balancing based on predicted PDU output port power values that occur during routine daily time periods for high workload (e.g., starting at stock market open or beginning of bank hours).

For example at block 312 in a disclosed embodiment, system 200 creates the switching rules based on recognized power patterns, where the switching rules, alternatively or additionally include predicted output port power values based on the measured PDU output port power values associated with the loads. For example, in a disclosed embodiment, system 200 uses the switching rule for switching input phases that connect to one or more PDU output ports 206 in response to predicted differing PDU output port power utilization of one or more loads that may last a threshold period of time or more, for example (e.g., at least 5 minutes, or at least 30 minutes). Operations continue at block 314 following entry point B in FIG. 3B.

In FIG. 3B at block 314, system 200 switches input phases of one or more PDU output ports based on the switching rules. A disclosed embodiment includes a redundant system architecture or system that has PDU redundancy and uses N+1, N+2, 2N, etc. power, (e.g., where N, or N-mode, represents a minimum number of PDUs required for the connected loads to remain fully operational in the event that one of the redundant PDUs fails, and N+1, N+2, 2N power or N+x represents a number x of extra PDUs connected to each load that are present for redundancy purposes). In embodiments where the loads are connected to redundant PDUs (e.g., 2N mode), the loads can be transitioned to N-mode such that they are powered entirely off of a first (primary) set of PDUs while the switches on the second set of PDUs (redundant PDUs) are configured based on the switching rules. Once switching is completed on the second set of PDUs, power distributed to the loads can be transitioned entirely to the second set of PDUs and the process is repeated while the switches on the first set of PDUs (primary PDUs) are configured based on the switching rules. The first set of PDUs can then be brought into a normal mode again (e.g., 2N mode), and the power can be balanced accordingly (e.g., 50% on each set of PDUs) with proper switch configurations for input phase load balancing. This may be done to minimize line disruption during configuration of load switches 205.

At block 316, system 200 returns to block 306 in FIG. 3A to update measured PDU output port power values over time, and continues as described above. In a disclosed embodiment, for example system 200 periodically updates the PDU output port power values over time, which are used to create or update the switching rules at block 312 of FIG. 3A. For example, in a disclosed embodiment, the measured PDU output port power values of PDU output ports 206 that distribute power to the associated loads may change over time, and the updated measured PDU output port power values can enable learning updated recognized power patterns and/or new recognized power patterns, which can be used to create enhanced or improved switching rules.

FIG. 4A illustrates a PDU 400 of Wye-configuration input for the PDU 202 and switch bank 204 of FIG. 2. As shown, PDU 400 includes a switch bank 402 of an array of output load switches, such as load switches 205 of the switch bank 204 in FIG. 2, coupled to each of the respective PDU output ports 404 P1-PN of a disclosed embodiment. The power inputs Phase A, Phase B, and Phase C are coupled to the switch bank 402 by a respective ones of series-connected circuit breaker (CB) and relay (R) 406, CB1-CBN and R1-RN with Neutral coupled to the switch bank 402 by the respective circuit breakers CB1-CBN. The array of output load switches of the switch bank 402 provide respective ones of Phase A, Phase B, and Phase C to the PDU output ports 404, P1-PN.

FIG. 4B illustrates an example portion of switch bank 402 for one output port 404 PM of the Wye-configuration input PDU 400 of FIG. 4A of a disclosed embodiment. FIG. 4B illustrates an example switch group of example PDU output load switches 410, SWITCH1, SWITCH2, and SWITCH3 that are controlled to provide input phase balancing, with each respective switch group configured for connection to each of the respective PDU output ports 404 P1-PN. PDU output load switches 410, SWITCH1, SWITCH2, and SWITCH3 can be implemented by different types of electrical switching devices, for example, based on selected switching control options and properties of the connected loads. For example, the PDU output load switches 410 SWITCH1, SWITCH2, and SWITCH3 can be implemented using relays as the electrical switching devices, or implemented with solid state switching devices, such as Triac switching devices, Insulated Gate Bipolar Transistor (IGBT) switching devices, and Metal Oxide Semiconductor Field Effect Transistor (MOSFET) switching devices.

As shown, in switch group 410, the switch 410, SWITCH1 is connected to power input Phase A, the switch 410, SWITCH2 is connected to power input Phase B, and the switch 410, SWITCH3 is connected to power input Phase C. One of the three PDU output load switches 410, SWITCH1, SWITCH2, or SWITCH3 is operatively controlled to connect an associated power input Phase A, Phase B, or Phase C to a line side of a given one of the respective PDU output ports 404 P1-PN with the neutral input connected to the other side of each of the respective PDU output ports 404 P1-PN of disclosed embodiments. As shown, the PDU output load switch 410, SWITCH1 connects power input Phase A to the line side of PDU output port 404 PM. For the Wye-configuration input PDU 400, the three PDU output load switches 410, SWITCH1, SWITCH2, and SWITCH3 are required for maximum flexibility for three-phase input phase load balancing. It should be understood that one or multiple output ports within the output ports 404 P1-PN may also be connected to output load switches in a similar fashion to output load switches 410, SWITCH1, SWITCH2, SWITCH3, such that other output ports may also be connected to input Phase A similar to output port 404 PM connected by the illustrated output load switches 410, SWITCH1 and used to intelligently balance the input power being pulled from each input line or power inputs Phase A, Phase B, and Phase C. It should be understood that the disclosed embodiments are not limited to the illustrated three load switches 410, SWITCH1, SWITCH2, and SWITCH3. In a disclosed embodiment, respective PDU output load switches 410, SWITCH1, SWITCH2, or SWITCH3, used with each of the output port 404 P1-PN, are operatively controlled to intelligently balance the input power being pulled from each input line or power inputs Phase A, Phase B, and Phase C. It should be understood fewer switches could be used, with limitations to input phase balancing, for example based on selected tradeoffs to balance one or more of cost, size, design complexity or capability.

FIG. 5A illustrates an example PDU 500 for a Delta-configuration input, (e.g., the Neutral input is not used) including a switch bank 502 of an array of output load switches, such as illustrated in the example switch bank 502 of FIG. 5B. For example, the switch bank 502 provides input Phase lines A, B, Phase lines B, C, or Phase lines C, A coupled to respective ones of the PDU output ports 504 P1-PN. PDU 500 is configured to automatically connect to the input voltage of the Delta-configuration with two Phase lines of inputs Phase A, Phase B, and Phase C coupled to respective PDU output ports. The power inputs Phase A, Phase B, and Phase C are coupled to the switch bank 502 by a respective ones of series-connected circuit breaker (CB) and relay (R) 506, CB1-CB9 and R1-R9. Nine circuit breakers and relays are shown for illustrative purposes only. Any number of circuit breakers and relays could be used depending upon the number of output ports used.

FIG. 5B is a schematic and block diagram of example PDU output load switches for the Delta input power configuration PDU 500 of FIG. 5A of a disclosed embodiment. In a disclosed embodiment, for example, the switch bank 502 for the Delta input power configuration includes two switch groups 510, 512 of three load switches 510, 512 SWITCH1, SWITCH2, and SWITCH3. In a disclosed embodiment, the illustrated six load switches are used with each PDU output port 504, P1-PN for maximum flexibility with the Delta input. The PDU output load switches 510 SWITCH1, SWITCH2, and SWITCH3, and the PDU output load switches 512 SWITCH1, SWITCH2, and SWITCH3 can be implemented using relays as the electrical switching devices, or implemented with various solid state switching devices. The PDU output load switches 510 SWITCH1, SWITCH2, and SWITCH3, and the PDU output load switches 512 SWITCH1, SWITCH2, and SWITCH3 of the respective switch groups 510, 512 are operatively controlled to respectively switch in different Phase lines, such as Phase lines A, B, Phase lines B, C, or Phase lines C, A to each given PDU output port 504 of the respective PDU output ports 504, P1-PN. As shown, switch 510 SWITCH1 and switch 512 SWITCH2 connect Phase lines A, B to power inputs of the PDU output port 504, P2. It should be understood that the disclosed embodiments are not limited to the illustrated six load switches used with each PDU output port 504, P1-PN; fewer than the six switches could be used to achieve input phase load balancing, for example based on selected tradeoffs to balance one or more of cost, size, design complexity or capability.

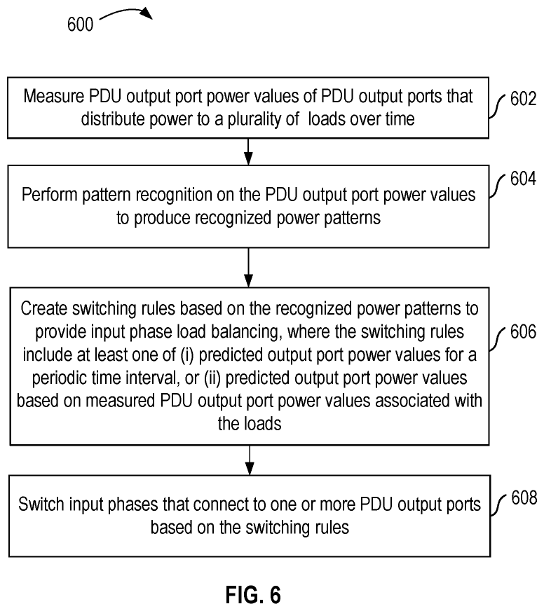

FIG. 6 illustrates a method 600 for implementing three-phase power distribution unit (PDU) output load switching for input phase balancing of a disclosed embodiment. Method 600 illustrates features and operations of method 300 of disclosed embodiments. The method 600 can be implemented by the system 200 in conjunction with the computer 101 of the cloud environment 100 of FIG. 1 with the PDU Output Load Switching Control Code 182.

At block 602, system 200 measures PDU output port power values of PDU output ports 206 that distribute power to a plurality of loads over time. In a disclosed embodiment, a respective current sensor 211 measures current to each PDU output port for providing a measured current signal for each of the respective loads. In a disclosed embodiment, PDU output port power values can vary based on system utilization for one or more loads connected to respective PDU output ports, for example, higher power values will be seen during times of high utilization. At block 604, system 200 performs pattern recognition on the PDU output port power values to produce recognized power patterns. In a disclosed embodiment, the recognized power patterns can include differing PDU output port power utilization of one or more loads that may last a threshold period of time or more, for example (e.g., at least 5 minutes, or at least 30 minutes). In a disclosed embodiment, the recognized power patterns can include periodic time intervals of differing PDU output port power values of power utilization of one or more loads, for example that occur during routine daily time periods of high workload (e.g., starting at stock market open or beginning of bank hours).

At block 606, system 200 creates switching rules based on the recognized power patterns to provide input phase load balancing, where the switching rules include at least one of (i) predicted output port power values for a periodic time interval, or (ii) predicted output port power values based on the measured PDU output port power values associated with the loads. At block 608, system 200 switches input phases that connect to one or more PDU output ports based on the switching rules. In a disclosed embodiment, input phases are switched to one or more PDU port outputs based on the switching rules, for example, to connect PDU output ports to input phases for input phase balancing, such as based on recognized power patterns or typical patterns that last for at least a threshold period of time (e.g., at least 5 minutes) of differing output port power values, and predicted differing output port power values based on the measured PDU output port power values associated with the loads. In a disclosed embodiment, input phases are not switched for higher output port power values that increase briefly (e.g., predicted for 30 seconds or less).

While the foregoing is directed to embodiments of the present invention, other and further embodiments of the invention may be devised without departing from the basic scope thereof, and the scope thereof is determined by the claims that follow.

What is claimed is:

1. A method comprising:
measuring PDU output port power values of PDU output ports that distribute power to a plurality of loads over time;
performing pattern recognition on the PDU output port power values over time to produce recognized power patterns;
creating switching rules based on the recognized power patterns to provide input phase load balancing, wherein the switching rules include at least one of (i) predicted output port power values for a periodic time interval, or (ii) predicted output port power values based on the measured PDU output port power values associated with the loads; and
switching input phases that connect to one or more PDU output ports based on the switching rules.

2. The method of claim 1, further comprising:
identifying a three phase input power configuration of a Delta-configuration input, or a Wye-configuration input.

3. The method of claim 2, further comprising:
configuring PDU output load switches, based on the Delta-configuration input, or the Wye-configuration input, wherein the PDU output load switches are used for the switching the input phases that connect to one or more PDU output ports.

4. The method of claim 1, wherein the measuring the PDU output port power values of the PDU output ports that distribute power to the plurality of loads over time further comprises measuring current using respective current sensors coupled to each of the PDU output ports for providing a measured current signal for each of the respective loads.

5. The method of claim 1, wherein the performing pattern recognition on the PDU output port power values over time to produce recognized power patterns further comprises:
performing pattern recognition on the PDU output port power values to recognize differing power utilization of one or more PDU output ports that last for at least a threshold period of time that change three-phase input load balancing.

6. The method of claim 1, wherein the performing pattern recognition on the PDU output port power values over time to produce recognized power patterns further comprises:
performing pattern recognition on the PDU output port power values to identify periodic times of differing power utilization of one or more loads of at least a threshold period of time that change three-phase input load balancing.

7. The method of claim 1, wherein the creating switching rules based on the recognized power patterns to provide input phase load balancing further comprises:
identifying predicted differing power utilization of one or more PDU output ports at predicted periodic times that change three-phase input load balancing.

8. The method of claim 1, wherein the creating switching rules based on the recognized power patterns to provide input phase load balancing further comprises:
identifying predicted output port power values, of one or more PDU output ports, that change three-phase input load balancing.

9. The method of claim 1, wherein the switching input phases that connect to one or more PDU output ports based on the switching rules further comprises:
switching the input phases that connect to one or more PDU output ports a set time before the predicted periodic time interval of the differing output port power values of a differing power utilization.

10. The method of claim 1, wherein the switching input phases that connect to one or more PDU output ports based on the switching rules further comprises:
switching the input phases that connect to one or more PDU output ports for input phase load balancing based on predicted output port power values of differing power utilization predicted to last at least a threshold time interval.

11. A system, comprising one or more computer processors; and a memory containing a program which when executed by the one or more computer processors performs an operation, the operation comprising:
measuring PDU output port power values of PDU output ports that distribute power to a plurality of loads over time;
performing pattern recognition on the PDU output port power values over time to produce recognized power patterns;
creating switching rules based on the recognized power patterns to provide input phase load balancing, wherein the switching rules include at least one of (i) predicted output port power values for a periodic time interval, or (ii) predicted output port power values based on the measured PDU output port power values associated with the loads; and
switching input phases that connect to one or more PDU output ports based on the switching rules.

12. The system of claim 11, wherein the measuring the PDU output port power values of PDU output ports that distribute power to the plurality of loads over time further comprises:
measuring current using respective current sensors coupled to each of the PDU output ports for providing a measured current signal for each of the respective loads.

13. The system of claim 11, wherein the performing pattern recognition on the PDU output port power values to produce recognized power patterns further comprises:
performing pattern recognition on the PDU output port power values to recognize differing power utilization of one or more PDU output ports that lasts for at least a threshold period of time that change three-phase input load balancing.

14. The system of claim 11, wherein the performing pattern recognition on the PDU output port power values to produce recognized power patterns further comprises:
performing pattern recognition on the PDU output port power values to identify periodic times of differing power utilization of one or more loads of at least a threshold period of time that change three-phase input load balancing.

15. The system of claim 11, wherein the creating switching rules based on the recognized power patterns for input phase load balancing further comprises:
identifying predicted output port power values, of one or more PDU output ports, that change three-phase input load balancing.

16. A computer program product comprising a computer-readable storage medium having computer-readable program code embodied therewith, the computer-readable program code executable by one or more computer processors to perform an operation comprising:
measuring PDU output port power values of PDU output ports that distribute power to a plurality of loads over time;
performing pattern recognition on the PDU output port power values over time to produce recognized power patterns;
creating switching rules based on the recognized power patterns to provide input phase load balancing, wherein the switching rules include at least one of (i) predicted output port power values for a periodic time interval, or (ii) predicted output port power values based on the measured PDU output port power values associated with the loads; and
switching input phases that connect to one or more PDU output ports based on the switching rules.

17. The computer program product of claim 16, wherein the measuring the PDU output port power values of PDU output ports that distribute power to the plurality of loads over time further comprises:
measuring current using respective current sensors coupled to each of the PDU output ports for providing a measured current signal for each of the respective loads.

18. The computer program product of claim 16, wherein the performing pattern recognition on the PDU output port power values to produce recognized power patterns further comprises:
performing pattern recognition on the PDU output port power values to recognize differing power utilization of one or more PDU output ports that lasts for at least a threshold period of time that change three-phase input load balancing.

19. The computer program product of claim 16, wherein the performing pattern recognition on the PDU output port power values to produce recognized power patterns further comprises:
performing pattern recognition on the PDU output port power values to identify periodic times of differing power utilization of one or more loads of at least a threshold period of time that change three-phase input load balancing.

20. The computer program product of claim 16, wherein the creating switching rules based on the recognized power patterns to provide input phase load balancing further comprises:
identifying predicted output port power values, of one or more PDU output ports, that change three-phase input load balancing.
